(19) United States
(12) Patent Application Publication
(10) Pub. No.: US 2007/0153446 A1
(43) Pub. Date: Jul. 5, 2007

(54) MOBILE COMPUTING APPARATUS

(75) Inventors: Yona Newman, Ra'Anana (IL); Nissim Cohen-Matzliah, Tel Aviv-Yaffo (IL); Carol Ronen, Tel Aviv-Yaffo (IL)

Correspondence Address: MOTOROLA, INC;INTELLECTUAL PROPERTY SECTION, LAW DEPT, 8000 WEST SUNRISE BLVD, FT LAUDERDAL, FL, 33322, US

(73) Assignee: MOTOROLA, INC., Schaumburg, IL (US)

(21) Appl. No.: 11/610,015

(22) Filed: Dec. 13, 2006

(30) Foreign Application Priority Data
Dec. 29, 2005 (GB) 0526491.6

(51) Int. Cl. H02B 1/00

(52) U.S. Cl. 361/600

(57) ABSTRACT

Mobile computing apparatus includes a portable computer (101) having a display module (105) and an arrangement (500) for providing illumination in the display module, the arrangement including a light source (222) external to the display module, a light guide (223) for guiding light from the light source toward the display module and a coupler (501) for coupling light from the light guide into the display module. The arrangement may be attached to a docking station (200) adapted to receive the portable computer.

### FIELD OF THE INVENTION

The present invention relates to mobile computing apparatus. In particular, the invention relates to apparatus including a portable computer and an arrangement to be used with the portable computer such as for use in a vehicle.

### BACKGROUND OF THE INVENTION

Portable computers (also known as ‘laptop’ or ‘notebook’ computers) are widely used today. Such computers may find mobile use in vehicles, particularly by certain specialised groups of users such as the police, by attachment of the computer to a docking station in the vehicle.

Such computers often include an electro-optical liquid crystal display (lcd) screen together with a screen illuminator such as a cold cathode fluorescent lamp. The illuminator enhances the contrast observed on the lcd screen by a user between areas, e.g. pixels, of the screen which are driven ‘on’ by a controlling electric field and those that remain ‘off’. Portable computers have a limited battery capacity and a limited heat dissipation capability. In consequence, the light levels which are obtainable from the illuminator can be lower than desired. In particular, if the portable computer is used in sunlight the screen contrast may be poor.

### SUMMARY OF THE INVENTION

According to the present invention in a first aspect there is provided apparatus for mobile computing as defined in claim 1 of the accompanying claims.

According to the present invention in a second aspect there is provided a portable computer as defined in claim 22 of the accompanying claims.

Further features of the invention are as defined in the accompanying dependent claims and in the embodiments of the invention to be described.

Embodiments of the present invention will now be described by way of example with reference to the accompanying drawings, in which:

### BRIEF DESCRIPTION OF THE DRAWINGS

FIG. 1 is a front view of a portable (laptop) computer which may be used in accordance with embodiments of the invention.

FIG. 2 is a rear angled perspective view of the portable computer of FIG. 1 received by a docking station which may be used in accordance with embodiments of the invention.

FIG. 3 is a front angled perspective view of the docking station of FIG. 2 removed from the mobile portable computer together with a light delivery module for attachment to the docking station for use in accordance with embodiments of the invention.

FIG. 4 is a side view showing the docking station and the light delivery module of FIG. 3 with the docking station mounted on and fixed to the docking station.

FIG. 5 is a simplified side view of an arrangement embodying the invention of optical components of the light delivery module of FIGS. 3 and 4 coupled to optical components of the portable computer of FIGS. 1 and 2.

FIG. 6 is a simplified side view of an alternative arrangement embodying the invention of optical components of the light delivery module of FIGS. 3 and 4 coupled to optical components of the portable computer of FIGS. 1 and 2.

FIG. 7 is a simplified side view of a further arrangement embodying the invention of optical components of the light delivery module of FIGS. 3 and 4 coupled to optical components of the portable computer of FIGS. 1 and 2.

FIG. 8 is a cross-section, taken on a plane indicated by a line 8-8 in FIG. 1, of a first form of a display module of the portable computer of FIGS. 1 and 2.

FIG. 9 is a cross-section, taken on the plane indicated by the line 8-8 in FIG. 1, of a second form of a display module of the portable computer of FIGS. 1 and 2.

FIG. 10 is a cross-section, taken on the plane indicated by the line 8-8 in FIG. 1, of a third form of a display module of the portable computer of FIGS. 1 and 2.

FIG. 11 is a cross-section, taken on the plane indicated by the line 8-8 in FIG. 1, of a fourth form of a display module of the portable computer of FIGS. 1 and 2.

FIG. 12 is a diagrammatic side view (in three parts illustrating three different orientational configurations) of an arrangement embodying the invention alternative to that of FIG. 4.

### DESCRIPTION OF EMBODIMENTS OF THE INVENTION

In relation to the following description, components shown in different drawings with the same reference numerals basically perform the same function.

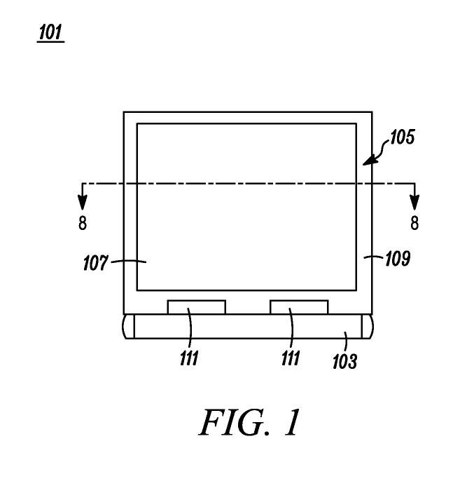

FIG. 1 is a front view of a portable (laptop) computer 101. The portable computer 101 includes a body 103 which is normally on a horizontal or approximately horizontal surface and houses various known components (not shown) including various processors, a hard disc and a battery. The portable computer 101 includes a display module 105 described in more detail later. The display module 105 includes a display screen 107 and a case 109, edges of which are shown in FIG. 1 around the display screen 107. Hinged connections 111 connect the display module 105 to the body 103 whereby the display module 105 may be rotated about the hinged connections 111 to allow a suitable viewing angle of the display screen 107 relative to the body 103 to be selected by a user. The display module 105 may generally be in a range of from 45 degrees to 135 degrees relative to the body 103, although a suitable viewing angle will typically be found with the angle between the display module 105 and the body 105 between ninety and 120 degrees.

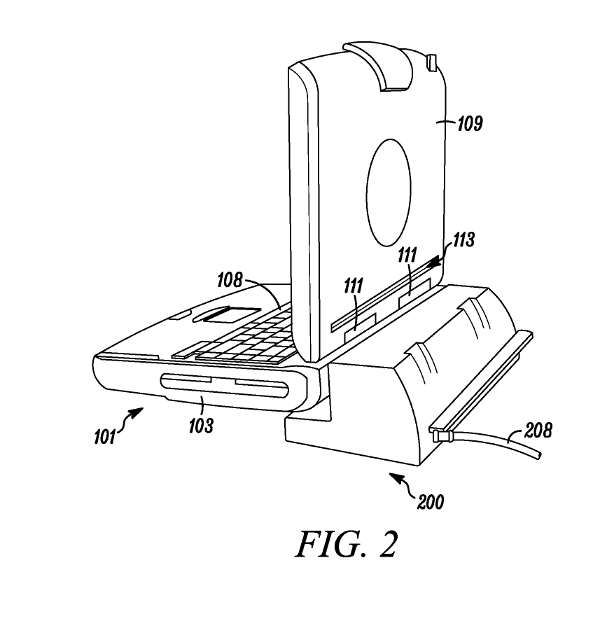

FIG. 2 is a rear angled perspective view of the mobile computer 101 received by a docking station 200. A keyboard 108 on an upper face of the body 103 is shown in FIG. 2. A rear face of the case 109 of the display module 105 is also shown in FIG. 9. The rear face of the case 109 includes a horizontal slot 113 providing access to the interior of the display module 105. The slot 113 is used in a manner described later.

The docking station 200 allows the portable computer 101 to be connected to a power supply (not shown) external to the portable computer 101. The docking station 200 is connected to the external power supply via an electrical cable 208. In particular, the external power supply may be that of a vehicle (not shown) carrying the docking station 200 and the mobile computer 101. Alternatively, the external power supply may be a mains supply. If appropriate, the portable computer 101 may also be connected through the docking station 200 to peripheral devices (not shown) in a known manner.

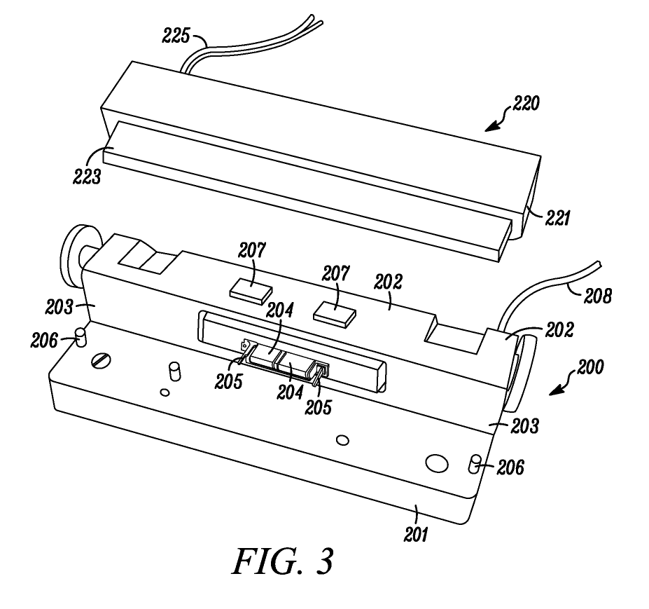

FIG. 3 is front angled perspective view of the docking station 200 removed from the portable computer 101. Also shown in FIG. 3 is a light delivery module 220 for attachment to the docking station 200. The light delivery module 220 is shown in FIG. 3 to include a case 221, a light guide plate 223 and an electrical cable 225. Operation of the light delivery module 220 is described later. The docking station 200 includes a front horizontal plate 201 which, as illustrated in FIG. 2, is used to support part of the body 103 of the portable computer 101 when attached to the docking station 200. The docking station 200 also includes a raised portion 202 providing a front wall 203 against which the mobile station 201 is located when attached to the docking station 200. Connectors 204 project from the front wall 203 of the raised portion 202 of the docking station 200. The connectors 204 allow the portable computer 101 to make appropriate electrical connections to the docking station 200 via complementary connections (not shown) on a rear part of the body 103 of the portable computer 101. Pins 205 projecting from the front wall 203 facilitate locating the portable computer 101 (in the manner shown in FIG. 2) by push fitting the body 103 to make the connections.

Screws 206 are fitted through the horizontal plate 201 of the docking station 200. The screws 206 allow the docking station 200 to be fixed to a suitable structure (not shown) such as a bulkhead of a vehicle. Plates 207 are provided welded to a top surface of the raised portion 202. The plates 207 project from the top surface of the raised portion 202 so that slots are formed between each plate 207 and an area of the top surface of the raised portion 202 underlying the plate 207. Complementary rigid strips (not shown) are provided on an underside of the case 221 of the light delivery module 220; the strips engage slidably in the slots provided by the plates 207 allowing the module 220 to be removably fixed to the top surface of the raised portion 202 of the docking station 200.

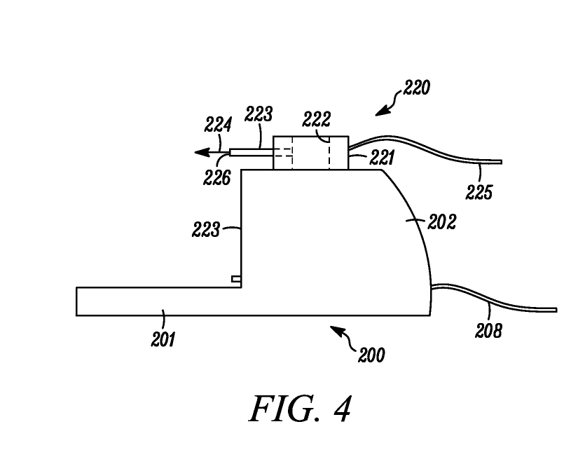

FIG. 4 is a side view showing the light delivery module 220 mounted on and fixed to the top surface of the raised portion 202 of the docking station 201. The module 220 includes inside the case 221 a light source 222 (indicated by dashed lines in FIG. 4). The light guide plate 223 contacts the light source 222 so that light from the light source 222 is directed into the light guide plate 223. A fibre optic light coupler (not shown) may optionally be employed to direct the light from the light source 222 into the light guide plate 223. The light guide plate 223 projects horizontally from a front surface of the case 221. As shown in FIG. 4, with the module 220 fitted to the raised portion 202 of the docking station 200 the light guide plate 223 is above (a rear part of) the front horizontal plate 201 of the docking station 200. The light source 222 is electrically energised via the electrical cable 225 connected to a power supply (not shown). The power supply may be the same as that to which the cable 208 of the docking station 200 is connected. When the light source 222 is electrically energised, light from the light source 222 is delivered along the light guide plate 223 and emerges at a front end 226 of the light guide plate 223 as indicated in FIG. 4 by an arrow 224.

The light guide plate 223 is a component which is known per se. It may have a polished rear edge to receive light from the light source 222 and a polished front edge 226. It may be made of a transparent material such as glass or a thermoplastic material. It may optionally incorporate light transmitting fibres.

The light source 222 is also a known component. However, the light source 222 is selected to be a powerful light source having a brightness of at least 1000 candelas per metre squared, preferably at least 1200 candelas per metre squared. The light source 222 may for example be a cold cathode fluorescent lamp or a plurality of bright leds (light emitting diodes) or an electroluminescent panel. The light source 222 may have an external heat sink (not shown) thermally coupled to it or to the docking station 200 for removal of heat generated in use by the light source 222. Alternatively, a fan (not shown) may be fitted to the light source 222 or to the docking station 200 to remove such heat.

When the portable computer 101 is received by the docking station 200 (as shown in FIG. 2) and the light delivery module 220 is also attached to the raised portion of the docking station 200, the light guide plate 223 slides through the slot 113 (shown in FIG. 2) in the case 109 of the display module 105 into an interior region of the display module 105 to couple with optical components inside the display module 105 in a manner now to be described.

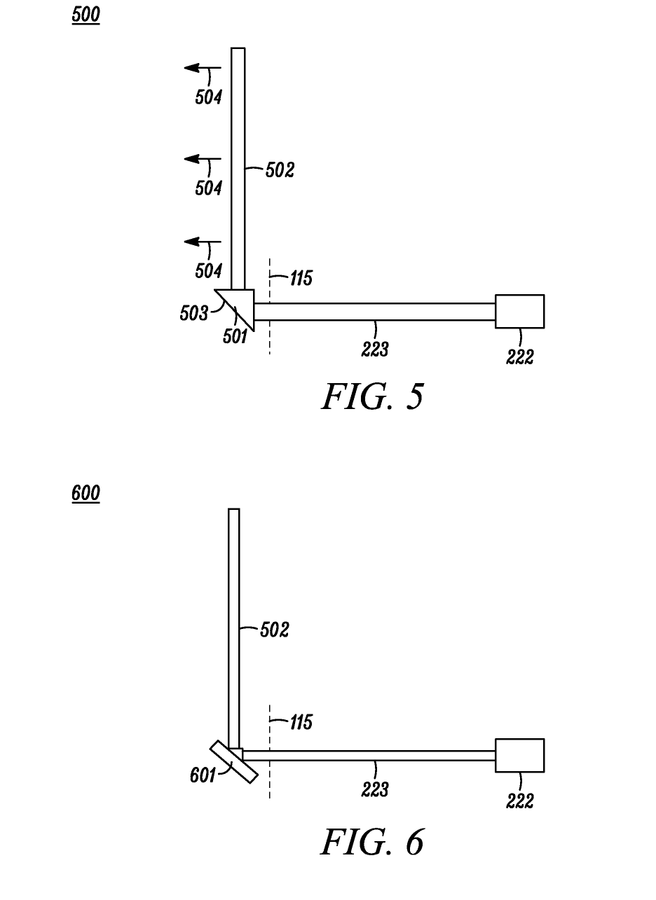

FIG. 5 is a simplified side view of an arrangement 500 of optical components only of the light delivery module 220 and of the display module 105 of the portable computer 101 showing how the light guide plate 223 couples, in accordance with an embodiment of the invention, with other optical components inside the display module 105. A rear outer surface of the case 109 of the display module 105 is indicated by a dashed line 115. The light guide plate 223 is horizontally disposed and contacts at its front end 226 an optical prism 501 fixed inside the display module 105. The optical prism 501 is also contacted by a vertically disposed light diffuser 502, at a lower end of the light diffuser 502, located inside the display module 105. The optical prism 501 is an example of an optical coupler to couple light between the guide plate 223 and the light diffuser 502. The optical prism 501 has a reflective surface 503 which re-directs light originating from the light source 222 and emerging from the light guide plate 223 into the light diffuser 502.

The optical prism 501 has a length, measured along an axis perpendicular to the plane of FIG. 5, which is not less than a corresponding dimension of the light guide plate 223 and a corresponding dimension of the light diffuser 502 along that axis. The optical prism 501 may extend across at least 75 per cent of the width of the display module 105 (measured perpendicular to the plane of FIG. 5).

The optical prism 501 may be retained in position in a known manner, e.g. by supports (not shown), e.g. moulded plastic supports, or adhesive strips (not shown) inside the display module 105.

In use, light from the light source 222 is directed along the light guide plate 223 toward the prism 501 and is re-directed by the prism 501 along the diffuser 502. 5). The diffuser 502 is a component which is known per se and has a polished edge where it receives light from the prism 501 and has a roughened or microprofiled surface on one side only, depending on how the display screen 107 of the portable computer 101 is to be illuminated. For example, where the display screen 107 is to be backlit, in a manner illustrated later, the diffuser 502 is roughened or microprofiled on its side which when vertical faces away from the light source 221. Alternatively, where the display screen 107 is to be frontlit, in a manner illustrated later, the diffuser 502 is roughened or microprofiled on its opposite side which when vertical faces toward the light source 221. In each case, the light directed into the diffuser 502 by the prism 501 is scattered by the roughened or microprofiled surface in a known manner generally in the direction in which the roughened or microprofiled surface faces but little or none of the light is emitted in the opposite direction. The scattered light thereby illuminates the display screen 107 of the portable computer 101 in one of the ways to be described later. Light from the diffuser 502 arranged to provide backlighting of the display screen 107 is indicated by arrows 504 in FIG. 5.

It should be noted that although the diffuser 502 acts as a diffuser in the same manner as known diffusers, it also acts as a light guide to direct light from the optical prism 501 into the interior of the diffuser 502. The diffuser 502 may for example be made of a polymeric material, such as a flexible transparent thermoplastic material, e.g. one of the materials known in the art for use in producing diffusers, e.g. a polycarbonate moulding.

In the above description with reference to FIG. 5 it is assumed that the arrangement of components is such that the diffuser 502 and the light guide plate 223 are in planes which are approximately mutually orthogonal. In practice, the plane of the diffuser 502 is selected by a user according to the viewing angle which the user selects for the display module 105. In general, the angle of this plane relative the plane of the light guide plate 223 may vary between angles which are greater than and less than ninety degrees. The prism 501 may be rotated in a known manner so that the apex 503 points along an axis which bisects the angle between the diffuser 502 and the light guide plate 223. Alternatively, or in addition, flexible light guiding couplers (not shown) may be provided at the respective ends of the light guide plate 223 and the diffuser 502 near the prism 501 to adjust the angle by which the light has to be rotated between the light guide plate 223 and the diffuser 502.

An alternative arrangement 600 of optical components embodying the invention to be used instead of the arrangement 500 of FIG. 5 is shown in FIG. 6. The prism 501 is replaced in the arrangement 600 by a mirror 601 which provides an alternative coupler to re-direct light from the light guide plate 223 into the diffuser 502 in a manner similar to the prism 501.

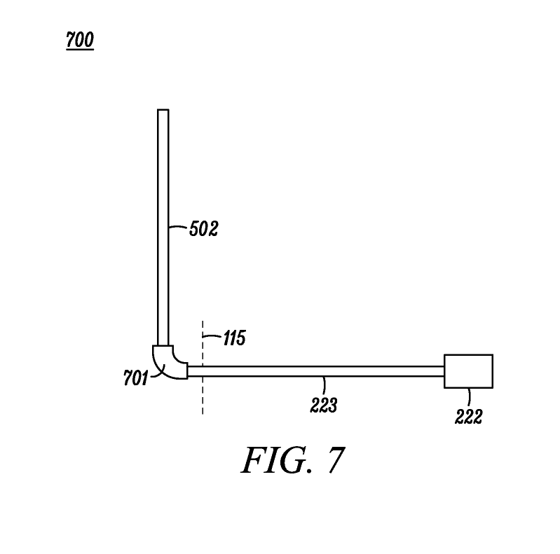

A further alternative arrangement 700 of optical components embodying the invention to be used instead of the arrangement 500 of FIG. 5 is shown in FIG. 7. The prism 501 is replaced in this case by a flexible light guiding coupler 701, which is a coupler alternative to the optical prism 501 of FIG. 5, which re-directs light from the light guide plate 223 into the diffuser 502. The light guiding coupler 701 may comprise a known component including light guides, e.g. optical fibres, embedded in the coupling 701, which are curved to provide the required re-direction of the light, and flexible to accommodate various angles of re-direction of the light.

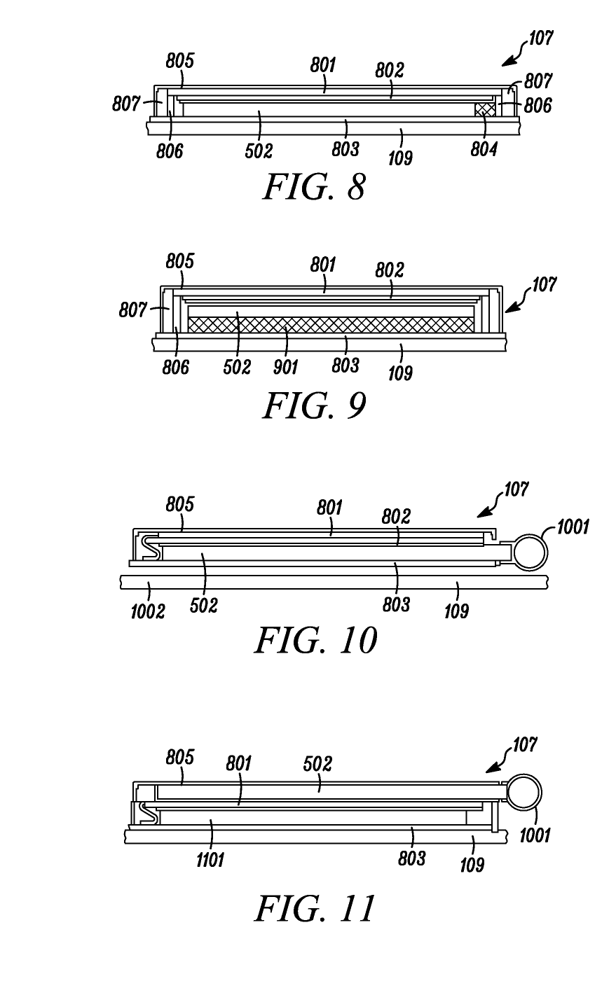

As noted earlier, the diffuser 502 is a known component and it may be incorporated in the display screen 107 of the portable computer 101 in a known manner. Examples of known constructions of the display screen 107 including the diffuser 502 are described with reference to FIGS. 8 to 11 as follows.

FIG. 8 is a cross-section, taken on a plane indicated by a line 8-8 in FIG. 1, of part of the display module 105 including the display screen 107 in a first form. The display screen 107 comprises a lcd (liquid crystal display) 801 and the diffuser 502. FIG. 8 gives a first example of how the diffuser 502 may be employed in the display screen 107 together with the lcd 801. The lcd 801 comprises an electro-optical lcd of a known kind wherein displayed information (e.g. as ‘pixels’) is provided by electrically controlled modulations of optical transmissivity of the lcd 801. The lcd 801 is supported by mountings 807 and is enclosed in a frame 805. The diffuser 502 is mounted behind the lcd 801. A glass plate 802 is an optional component provided between the lcd 801 and diffuser 502. The diffuser 502 is housed against a printed circuit board 804 which provides control electronics for the lcd 801. The printed circuit board 804 is located in front of a rear part of the case 109 (shown also in FIG. 2). A light source 804 is provided at an end of the diffuser 502. The light source may be a led (light emitting diode) light source, e.g. provided by a row of bright led light emitters. Opaque elastomeric strips 806 are provided inside the mountings 807 to prevent light being emitted laterally from the diffuser 502 (to the left as seen in FIG. 8) and from the light source 804 (to the right as seen in FIG. 8).

When the portable computer 101 is used in a first mode in which it is not used in conjunction with the docking station 200, the light source 804 incorporated in the display module 105 is energised by an internal battery (not shown) of the computer 101 and provides light to the diffuser 502 which the diffuser 502 employs to provide a backlight to the lcd 801. The light passes laterally through the diffuser 502 (in a direction from right to left as seen in FIG. 8) and is re-directed to illuminate the lcd 801 by a roughening or microprofile on a front surface of the diffuser 502. Alternatively, when the portable computer 101 is received by the docking station 200 (as shown in FIG. 2) and the light source 222 delivers light to the diffuser 502 in one of the ways embodying the invention described earlier with reference to FIGS. 5 to 7, the light passes upward through the diffuser 502 in a direction pointing out of the plane of the drawing of FIG. 8 and is re-directed to illuminate the lcd 801 by a roughening or microprofile on the front surface of the diffuser 502.

The light source 222 is desirably much brighter than the light source 804. For example, the brightness of the light source 222 may be at least twice, preferably at least three times, especially at least five times, the brightness of the light source 804. This is possible because the light source 222 is energised by an external power source and heat generated by the light source 804 may be removed separately (outside the portable computer 101) without damaging the portable computer 101. The greater brightness allows the display screen 107 to be seen satisfactorily by a user even in the presence of sunlight falling on the display screen 107.

The light source 804 may be switched off (manually or automatically) when one of the light delivery arrangements embodying the invention as described earlier with reference to FIGS. 5 to 7 is being used. Alternatively, the two light sources 804 and 221 may be used together.

FIG. 9 is a cross-section (taken on the plane indicated by the line 8-8 in FIG. 1) of a second form of the display module 107. FIG. 9 gives a second example of how the diffuser 502 may be employed in the display screen 107. The example shown in FIG. 9 is similar to that shown in FIG. 8 except that the light source 804 is replaced by a light source 901 which is a panel or array located behind the diffuser 502 and in front of the printed circuit board 804. The light source 901 may for example comprise a led light source or an electroluminescent panel.

FIG. 10 is a cross-section (taken on the plane indicated by the line 8-8 in FIG. 1) of the display module 105 in a third form. FIG. 10 gives a third example of how the diffuser 502 may be employed in the display screen 107. The example shown in FIG. 10 is similar to that shown in FIG. 8 except that the light source 804 is replaced by a fluorescent light 1001 such as provided by a cold cathode lamp. A connector 1002 is shown in FIG. 10 to provide electrical energisation of the lcd 801.

FIG. 11 is a cross-sectional view of the display module 105 in a fourth form (taken on the plane indicated by the line 8-8 in FIG. 1). FIG. 11 gives a fourth example of how the diffuser 502 may be employed in the display screen 103. The fluorescent light 1001 is again provided at an end of the diffuser 502. In this case the diffuser 502 is located in front of the lcd 801. A reflector 1101 is located between the printed circuit board 804 and the lcd 810. In this case the diffuser 502 provides a front light for the lcd 801. A roughened or microprofiled surface of the diffuser 502 therefore faces in a direction opposite to that in which it faces in the examples illustrated in FIGS. 8 to 10. Light from the diffuser 502 in FIG. 11 is scattered toward the reflector 1101 and passes through the lcd 801 before and after reflection by the reflector 1101.

In the embodiments of the invention described above, the docking station 200 may include a switch (not shown), e.g. associated with the connectors 207, which is operated by the action of attaching to the portable computer 101 to the docking station 200. Operation of the switch may cause the light source 222 to be energised via the cable 225. The light source switch may turn off the light source 222 when the computer 201 is removed from the docking station 200.

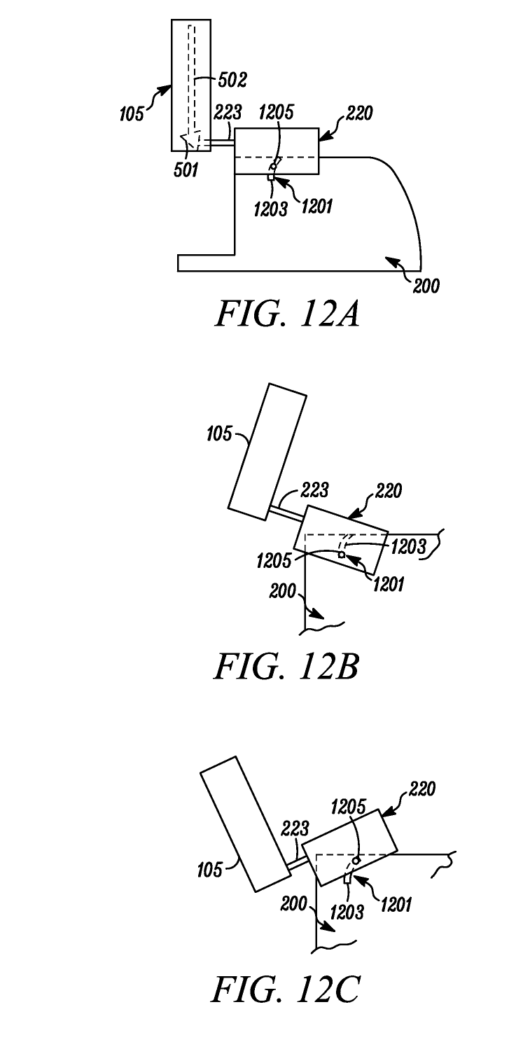

An alternative embodiment of the invention is illustrated diagrammatically in FIG. 12, parts (a), (b) and (c). As shown in FIG. 12(a), the light delivery module 220 (at its case 221) may be mounted on the docking station 200 (at its raised portion 202) by a pivot joint 1201. The pivot joint 1201 comprises a pivot rod 1205, attached to the light delivery module 220, in a slotted track 1203 provided in a member of or attached to the docking station 200. The pivot joint 1201 allows the light delivery module 220 to be tilted as the diffuser 502 is tilted. This is illustrated in FIG. 12 parts (b) and (c) in which the light delivery module 220 is shown tilted respectively upward and downward, and the position of the pivot 1205 is shown at the respective ends of the track 1203. The pivot joint 1201 allows the angle of orientation of the prism 503 to remain fixed with respect to the diffuser 502 and the light guide plate 223. The pivot joint 1201 also allows the body 103 of the portable computer to remain at the same height with respect to the docking station 200.

By the embodiments of the invention described above, the visibility of the display screen 103 of the portable computer 101 may beneficially be improved by use of the powerful light source 222 together with one of the light delivery arrangements shown in FIGS. 5 to 7. Beneficially, the light source 222 may be operated automatically when the computer 101 is used in conjunction with the docking station 200. The powerful light source 222 is energised by a power source external to the portable computer 101 and so does not cause a drain on the internal battery of the computer 101. Furthermore, heat generated by the light source 222 can be dissipated without harming the portable computer 101.

Examples of portable computers which may be used in the embodiments of the invention which have been described include the Motorola ML-850 and ML-900 (trade names) which have a ruggedised form and are particularly suitable for use in both a portable mode and a mobile, in-vehicle mode by specialised user groups such as the police and other emergency and security services.

1. Mobile computing apparatus including:
a portable computer having a display module and an arrangement for providing illumination in the display module, the arrangement including a light source external to the display module, a light guide for guiding light from the light source toward the display module and an optical coupler for coupling light from the light guide into the display module.

2. Apparatus according to claim 1 wherein the portable computer includes a computer body attached to the display module and the apparatus includes a docking station adapted to be connected to an electrical energy source and to receive a surface of the computer body to provide an electrical connection to the computer body, wherein the light source is adapted to be attached to or mounted on the docking station.

3. Apparatus according to claim 2 including a pivot joint between the light source and the docking station.

4. Apparatus according to claim 3 wherein the light source is adapted to receive electrical energy from the same external source as the docking station.

5. Apparatus according to claim 4 adapted for use in a vehicle and wherein the light source is adapted to receive electrical energy from a power supply of the vehicle.

6. Apparatus according to claim 5 including a switch for controlling energising of the light source, the switch being adapted to energise the light source when the computer body is received by the docking station.

7. Apparatus according to claim 6 wherein the display module includes a display screen including an electro-optical display and a light diffuser to provide illumination of the electro-optical display, wherein the optical coupler is arranged to couple light into the light diffuser.

8. Apparatus according to claim 7 wherein the electro-optical display comprises a liquid crystal display having an electrically controlled optical transmissivity.

9. Apparatus according to claim 8 wherein the light diffuser is located behind the electro-optical display and is operable to provide rear illumination of the electro-optical display.

10. Apparatus according to claim 8 wherein the light diffuser is located in front of the electro-optical display and is operable to provide front illumination of the electro-optical display, the display module also including a reflector located behind the electro-optical display to reflect light from the diffuser.

11. Apparatus according to claim 10 wherein the light guide comprises a plate or sheet of polymeric material or glass.

12. Apparatus according to claim 11 wherein the optical coupler is adapted to receive light from the light guide at an end edge of the light guide.

13. Apparatus according to claim 12 wherein the optical coupler is adapted to change a direction of light from the light guide into the display module.

14. Apparatus according to claim 13 wherein the optical coupler is adapted to change a direction of light from the light guide by an angle in the range of from 45 degrees to 135 degrees.

15. Apparatus according to claim 14 wherein the optical coupler extends across at least 75 per cent of a width of the display module.

16. Apparatus according to claim 15 wherein the optical coupler comprises a prism, a mirror or a flexible member including curved light guides.

17. Apparatus according to claim 16 wherein the optical coupler is fitted inside the display module.

18. Apparatus according to claim 17 wherein the light source is selected from a fluorescent light, a plurality of light emitting diodes, and an electroluminescent panel.

19. Apparatus according to claim 18 wherein the display module includes an internal light source operable to be energised by an internal battery of the portable computer when the computer body is not received in the docking station.

20. Apparatus according to claim 19 wherein the light source external to the display module has a brightness at least twice that of the internal light source included in the display module.

21. Apparatus according to claim 20 wherein the portable computer includes a hinged connection between the computer body and the display module.
